(19) United States
(12) Patent Application Publication
(10) Pub. No.: US 2025/0180796 A1
(43) Pub. Date: Jun. 5, 2025

(54) WAVEGUIDE FOR DISPLAYING AN IMAGE, AND HOLOGRAPHIC DISPLAY HAVING SUCH A WAVEGUIDE

(71) Applicant: Carl Zeiss Jena GmbH, Jena (DE)

(72) Inventors: Siemen KUEHL, Jena (DE); Christoph ERLER, Jena (DE); Stefan SCHWEDAT, Jena (DE)

(21) Appl. No.: 18/842,036

(22) PCT Filed: Jan. 30, 2023
(86) PCT No.: PCT/EP2023/052200

§ 371 Date: Aug. 27, 2024

(30) Foreign Application Priority Data
Feb. 28, 2022 (DE) 10 2022 104 676.1

(51) Int. Cl. F21V 8/00; B60Q 3/62; G03H 1/26

(52) U.S. Cl. CPC G02B 6/0036; G02B 6/0016; G02B 6/0018; G02B 6/0065; G03H 1/26; B60Q 3/62

(57) ABSTRACT

A waveguide for displaying an image includes a transparent base body having a coupling-in region and a coupling-out region which is spaced apart therefrom in a first direction. The coupling-out region has an image hologram having an imprinted image. The coupling-in region deflects at least some of the radiation originating from a light source such that the deflected part propagates as a coupled-in beam bundle in the base body by reflection as far as the coupling-out region and impinges on the image hologram. The image hologram deflects at least part of the impinging beam bundle in order to reconstruct the imprinted image such that the deflected part exits the base body via the front face or rear face such that the imprinted image is perceptible for a viewer.

### PRIORITY

This application claims the priority of German patent application DE 10 2022 104 676.1 filed Feb. 28, 2022, which is hereby incorporated herein by reference in its entirety.

### FIELD

The present invention relates to a waveguide for displaying an image and to a holographic display having such a waveguide.

### BACKGROUND

Modern micro-optical methods make it possible to integrate complex tasks such as imaging or monitoring of the environment, for example by means of holographic optical elements (HOE), discreetly or virtually invisibly, e.g. in large-format glass surfaces. This makes it possible to create, for example, transparent displays (e.g. in shop windows, refrigerated cabinets, car and truck side windows or windshields), illumination applications such as information and warning signals in any glass surface (e.g. in the field of architecture, in the automotive sector, or in design glazing), light-sensitive detection systems such as interior monitoring (e.g. eye tracking in vehicles and presence status of people in the interior). The disadvantage is that the light guidance within the panes must always be achieved through total internal reflection at the outer interfaces or through very complex microstructures between the outer interfaces. Such microstructures are very expensive to manufacture, especially for large-format applications (costs increase quadratically with the size of the area). Light guidance at the outer interfaces by total internal reflection is disadvantageously very susceptible to interference, since dirt or water on the outer interfaces, for example, inhibit the light guidance. In addition, the usable pane formats are very limited if the surrounding pane substrates are tinted, as is the case with car windows. A tint of 30% has the effect that less than 1% of light can propagate through the pane after only a distance of 30 cm between the input and output coupling surfaces. The rest is lost through absorption within the pane.

### SUMMARY

An object of the invention is to provide a waveguide for displaying an image with which the difficulties mentioned in the introduction can be overcome as completely as possible. Furthermore, the intention is to provide a holographic display having such a waveguide.

Since the input-coupled beam is reflected by one or more reflections, in particular by one or more total internal reflections at the interface between the first and second layers, the susceptibility to interference during light guidance can be significantly reduced.

The waveguide can be designed such that the beam that is incident on the image hologram covers the entire image hologram. However, it is also possible for the image hologram to have a first extent in the first direction which is greater than the extent of the beam cross section of the input-coupled beam in the first direction, wherein the input-coupled beam propagates in the first direction in such a way that it is incident on the image hologram multiple times at different locations which are offset from one another along the first direction, wherein for each incidence a portion of the incident beam is deflected for reconstructing the exposed image and the remaining portion of the beam continues to propagate.

This makes it possible to illuminate even very large extents of the image hologram along the first direction and thus to reconstruct the desired image of the image hologram.

In particular, the image hologram can have an efficiency curve in which the deflection efficiency increases from the first to the last incidence of the beam. This allows a more homogeneous reconstructed image to be generated.

The image hologram can in particular be designed as an image plane hologram, in which the reconstructed image is perceptible as a (substantially planar) image in the transparent base body.

The image hologram can be designed in such a way that the exposed image contains the image information which is reconstructed by means of the incident beam so that the image is perceptible to a viewer.

The image hologram can further be designed such that the exposed image is or comprises a holographic diffuser, which can generate the image with image information contained in the incident beam. Thus, in this design, the incident beam provides the image information, which can then be perceived as an image by a viewer, for example in the plane of the image hologram.

The waveguide can in particular be designed as a laminated glass or as a laminated glass pane. The waveguide can be designed here as a plane-parallel plate or be curved, wherein the front side and/or rear side can be curved. The waveguide can in particular be a window of a car or of a truck or be a part thereof.

Furthermore, the image hologram can be designed such that it comprises a plurality of exposed images that are designed for different wavelengths, with the result that, depending on the selected wavelength of the input-coupled radiation, one of the images of the image hologram can be selectively reconstructed.

The waveguide and the output-coupling region can in particular be designed to be transparent.

The image hologram can be designed as a reflective hologram or as a transmissive hologram.

In particular, the image hologram can comprise one or more spaced-apart output-coupling regions, each of which deflects at least a portion of the input-coupled beam in such a way that the deflected portion exits as diffuse or directed radiation. If the image hologram comprises a plurality of spaced-apart output-coupling regions, each of these can contain a portion of the exposed image.

The output-coupling regions can be designed as separate sub-holograms here such that no part of the image hologram is formed between the sub-holograms. In this case, the image hologram comprises the sub-holograms that are not connected in terms of area. However, it is also possible that the output-coupling regions are spaced apart from one another, but are all part of a single image hologram that is connected in terms of area; thus, the image hologram does not comprise separate sub-holograms, but is designed as a single hologram with the output-coupling regions spaced apart from one another.

If the plurality of spaced-apart output-coupling regions are designed in such a way that the output-coupled radiation exits in each case as diffuse radiation, the impression of a starry sky can be created, for example.

For example, each output-coupling region (e.g. each sub-hologram) can generate exactly one star of the starry sky to be created. However, it is also possible that at least one output-coupling region (e.g. each sub-hologram) generates two or more stars of the starry sky to be created.

Furthermore, the output-coupling regions can be spaced apart from one another but can all be part of a single image hologram that is connected in terms of area and generates the starry sky to be created.

In particular, it is possible that the plurality of output-coupling regions are designed such that they have two or more different output-coupling efficiencies. This can be used to output-couple radiation with different intensities at the individual output-coupling regions. Thus, for example, brighter and less bright stars can be displayed for the desired starry sky.

Of course, the output-coupling regions can also be designed in such a way that they have identical output-coupling efficiencies.

If the at least one output-coupling region is designed in such a way that the output-coupled radiation exits as directed radiation, this can be used, for example, to implement a reading light or reading lighting.

The waveguide can be designed in such a way that all output-coupling regions output-couple the radiation as diffuse radiation or as directed radiation. It is also possible that one or more of the output-coupling regions output-couple the radiation as diffuse radiation and one or more of the output-coupling regions output-couple the radiation as directed radiation.

The first layer can in particular be designed as a glass pane with a thickness of greater than 2 mm. Preferably, the first layer is not thicker than 5 mm.

The image hologram may be formed on the first side and/or the second side of the first layer.

Owing to the formation of the image hologram and/or the arrangement of a plurality of output-coupling regions of the image hologram (e.g. starry sky), a perceptible image can be generated when the input-coupled beam impinges on the image hologram. Preferably, the image information of the generated image is therefore contained in the image hologram (preferably completely). In this case, it can be stated that the input-coupled radiation is free of image information. The input-coupled radiation can therefore also be referred to as illumination radiation.

The first layer may comprise an input-coupling region projecting from the first side. The input-coupling region can comprise a planar or a curved entrance surface.

Furthermore, the input-coupling region can comprise a deflection element which deflects at least a portion of the radiation coming from the light source in such a way that the deflected portion of the input-coupled radiation is guided in the inner pane by reflections to the at least one output-coupling region.

The deflection element can be formed on the first side or second side of the first layer. If the deflection element is formed on the first side of the first layer, it is preferably designed as a transmissive deflection element. If the deflection element is formed on the second side of the first layer, it is in particular designed as a reflective deflection element.

The deflection element can be designed as a volume or surface grating and thus in particular as a hologram grating or relief grating.

The waveguide may comprise at least one further layer or pane which is bonded to the first layer, e.g. by means of a further adhesive layer. The refractive index of the further adhesive layer can be selected such that the light is reflected in each case due to total internal reflection at the interface between the further pane and the further adhesive layer and also at the interface between the first layer and the further adhesive layer. The further pane can be designed in the same way as the first layer, so that the further pane and the first layer can each be referred to as a light guide.

Furthermore, two or more further panes with corresponding adhesive layers can be formed as a layer stack on the first layer, wherein the further panes can be formed in the same way as the first layer.

Therefore, two or more light guides can be integrated in the laminated glass pane, thereby providing further design options for the desired illumination effects.

The image hologram can, for example, comprise substantially point-shaped output-coupling regions in order to be able to create the starry sky described, for example. However, it is also possible that the at least one output-coupling region has a larger surface area.

The waveguide can be designed, for example, as a laminated glass pane and in particular as a pane for a vehicle roof through which a person in the vehicle can look, for example.

The laminated glass pane can also be designed as another pane for a vehicle.

The vehicle can be a vehicle on land, in the water and/or in the air.

In particular, it can be a car or a truck.

Furthermore, a hologram can be formed in the input-coupling region of the waveguide. The hologram of the input-coupling region can be designed as a transmissive hologram or as a reflective hologram.

In the holographic display, the light source can comprise one or more light-emitting diodes. In particular, the light-emitting diodes can emit light with different wavelengths.

The light source is preferably designed to emit radiation in the visible wavelength range. In particular, the radiation can be white light and/or colored light (such as red, green and/or blue light). Furthermore, the light source can be designed so that it can produce and emit a plurality of different colors. This is preferably controllable or adjustable. The light source may comprise one or more LEDs.

Furthermore, the holographic display can comprise a control unit for controlling the light source or the light-emitting diodes.

The holographic display can be designed in such a way that the light from the light source is incident on and enters the base body directly without passing through further optical elements. However, it is also possible for the holographic display to comprise at least one optical element (such as a lens) arranged between the light source and the waveguide, with the result that the light from the light source passes through this optical element and only then is incident on the base body.

It goes without saying that the features mentioned above and the features yet to be explained hereinafter can be used not only in the specified combinations but also in other combinations or on their own, without departing from the scope of the present invention.

The invention will be explained in even greater detail below on the basis of exemplary embodiments with reference to the accompanying drawings, which likewise disclose features essential to the invention. These exemplary embodiments are used for illustration only and should not be construed as limiting. For example, a description of an exemplary embodiment having a multiplicity of elements or components should not be construed as meaning that all of these elements or components are necessary for implementation. Rather, other exemplary embodiments may also contain alternative elements and components, fewer elements or components, or additional elements or components. Elements or components of different exemplary embodiments can be combined with one another, unless stated otherwise. Modifications and variations that are described for one of the exemplary embodiments can also be applicable to other exemplary embodiments. In order to avoid repetition, elements that are the same or correspond to one another in different figures are denoted by the same reference signs and are not explained repeatedly.

### BRIEF DESCRIPTION OF THE DRAWINGS

FIG. 1 shows a schematic sectional view of a first embodiment of the holographic display with the waveguide;

FIG. 2 shows a plan view of the image hologram of the waveguide of FIG. 1;

FIG. 3 shows a plan view of the light source of FIG. 1;

FIG. 4 shows a sectional view of a further embodiment of the holographic display;

FIG. 5 shows a sectional view of an embodiment of the laminated glass pane together with a light source;

FIG. 6 shows a diagram of the wavelength-dependent refractive index curve of the inner pane and of the adhesive layer;

FIG. 7 shows a diagram showing the wavelength dependence of the critical angle for total internal reflection at the boundary between the inner pane and the adhesive layer;

FIG. 8 shows a sectional view according to FIG. 1 of a further embodiment of the laminated glass pane;

FIG. 9 shows a sectional view according to FIG. 1 of a further embodiment of the laminated glass pane;

FIG. 10 shows a sectional view according to FIG. 1 of a further embodiment of the laminated glass pane;

FIG. 11 shows a sectional view according to FIG. 1 of a further embodiment of the laminated glass pane;

FIG. 12 shows a sectional view according to FIG. 1 of a further embodiment of the laminated glass pane;

FIG. 13 shows a sectional view according to FIG. 1 of a further embodiment of the laminated glass pane;

FIG. 14 shows a sectional view according to FIG. 1 of a further embodiment of the laminated glass pane;

FIG. 15 shows an enlarged detailed view of a further embodiment of the laminated glass pane;

FIG. 16 shows an enlarged detailed view of a further embodiment of the laminated glass pane;

FIG. 17 shows a plan view of the inner side 9 of the laminated glass pane according to FIG. 1;

FIG. 18 shows a view according to FIG. 17 of a further embodiment of the laminated glass pane, and

FIG. 19 shows a further embodiment of the laminated glass pane.

### DETAILED DESCRIPTION

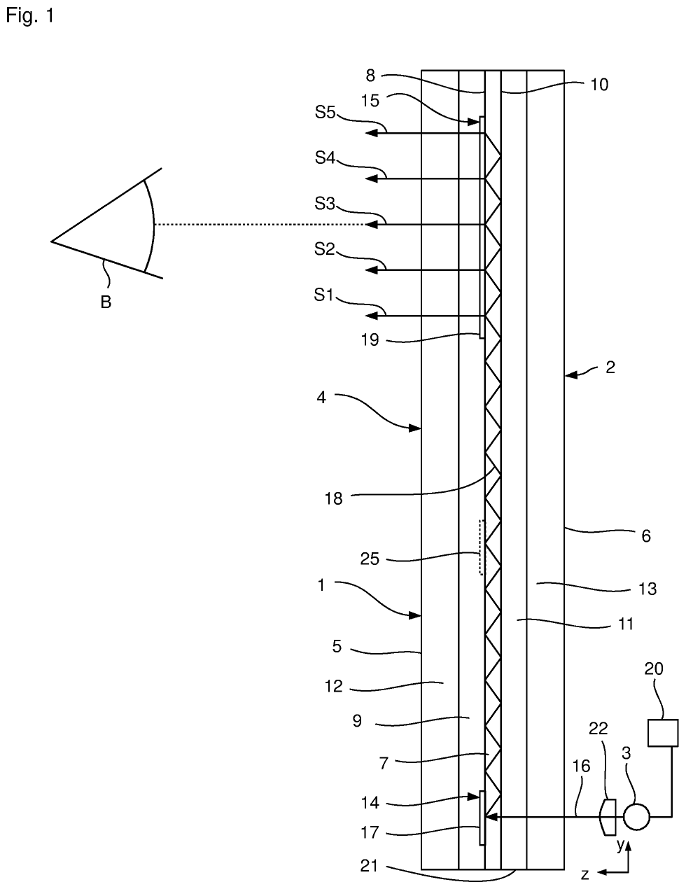

In the embodiment shown in FIG. 1, the holographic display 1 comprises a waveguide 2 for displaying an image, and a light source 3.

The waveguide 2 comprises a transparent base body 4 with a front side 5 and a rear side 6 and is plate-shaped. The base body 4 has a multi-layer structure and comprises a first layer 7, on the front side 8 of which a second layer 9 is applied and on the rear side 10 of which a third layer 11 is applied, so that the first layer 7 is positioned between the second and third layers 9, 11. The first layer 7 has a first refractive index which is greater than a second refractive index of the second layer 9 and further greater than a third refractive index of the third layer 11.

A first glass layer 12 is formed on the side of the second layer 9 oriented away from the first layer 7, and a second glass layer 13 is formed on the side of the third layer 11 oriented away from the first layer 7. The side of the first glass layer 12 oriented away from the first layer 7 can, for example, form the front side 5 of the base body 4. Furthermore, the side of the second glass layer 13 oriented away from the first layer 7 can form the rear side 6 of the base body 4. The transparent base body can therefore also be referred to as a laminated glass pane. The base body 4 can, for example, be designed as a window of a vehicle, such as the windshield or a side window of a car or truck.

Furthermore, the waveguide 2 comprises an input-coupling region 14 and an output-coupling region 15 spaced from the input-coupling region 14 in a first direction (here the y-direction).

As can be seen from the schematic illustration in FIG. 1, the light source 3 emits radiation 16 which enters the transparent base body 4 via the rear side 6 and is incident on an input-coupling element 17 of the input-coupling region 14 which is arranged between the first layer 7 and the second layer 9 and deflects the radiation 16 in the direction of the output-coupling region 15 such that the radiation is guided as an input-coupled beam 18 in the first layer 7 to the output-coupling region 15 due to total internal reflections at the interface between the first layer 7 and the second layer 9 and at the interface between the first layer 7 and the third layer 11. In the output-coupling region 15, between the first layer 7 and the second layer 9, an image hologram 19 with an exposed image is formed, on which the guided beam 18 is incident. In this case, the beam 18 is at least partially deflected for the reconstruction of the exposed image in such a way that the deflected portion exits the base body 4 via the front side 5. This makes the exposed image perceptible to a viewer B.

In the embodiment described here, the image hologram is designed as an image plane hologram, as a result of which the viewer can perceive the reconstructed image as an image in the transparent base body 4.

As is further shown schematically in FIG. 1, the input-coupled beam 18 is incident on the image hologram 19 multiple times. For this purpose, the image hologram 19 is designed in such a way that only a portion of the respective incident beam 18 is deflected by the image hologram 19 for reconstruction. The remaining portion will, after total internal reflection at the interface between the first layer 7 and the second layer 9 and subsequent total internal reflection at the interface between the first layer 7 and the third layer 11, be incident again on the image hologram 19 but in a position offset in the y direction, wherein again only a portion thereof is deflected by the image hologram 19 for reconstruction and output-coupled via the front side 5 of the transparent base body 4. In this way, the image hologram 19 can thus be illuminated in stripes by means of the input-coupled beam 18, wherein the stripes along the first direction are preferably incident on the image hologram 19 in a manner adjacent to one another or with a partial overlap.

In the illustration in FIG. 1, only one chief ray is shown in a schematic manner for the radiation 16 and for the input-coupled beam 18. Of course, the radiation 16 has an extent in the first direction, e.g. pre-defined by the light source 3, which also determines the stripe height. The stripes can also be referred to as footprints of the input-coupled beam 18.

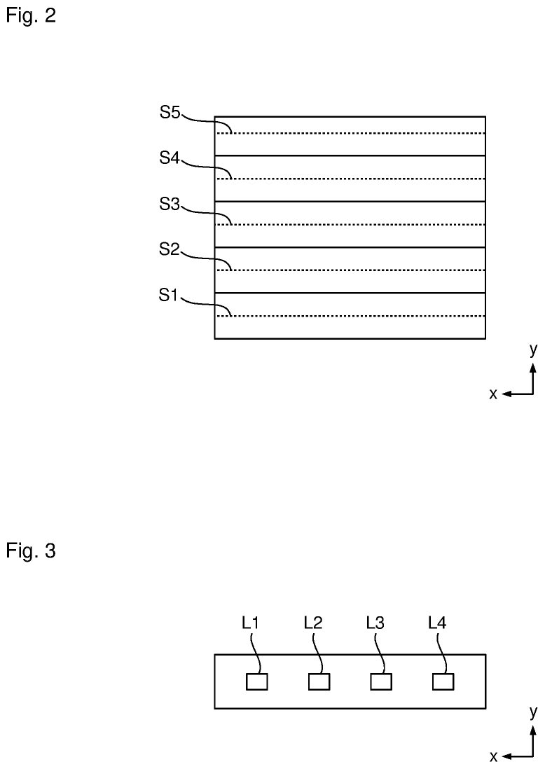

In the schematic plan view of the image hologram 19 in FIG. 2, the stripe-shaped illumination of the image hologram 19 with the input-coupled beam 18 is schematically shown by the five stripes S1, S2, S3, S4 and S5, wherein the dashed lines indicate the chief rays of each deflection and reconstruction. The stripe S1 is the first incidence of the beam 18 on the image hologram 19, the stripe S2 is the second incidence, etc. In the embodiment described here, the adjacent illumination stripes S1-S5 adjoin one another.

Since light is output-coupled each time the beam 18 is incident on the image hologram 19 (stripes S1-S5), the intensity of the reconstruction wave (the radiation deflected by the image hologram 19) decreases. As a result, the image thus reconstructed may exhibit a decrease in brightness that is noticeable for a viewer. To counteract this, the image hologram 19 can be provided with an efficiency curve which is designed in such a way that the deflection efficiency increases with each subsequent incidence. This means that the deflection efficiency for the first incidence S1 is smaller than for the second incidence S2, that the deflection efficiency for the second incidence S2 is smaller than for the third incidence S3, etc. This allows a more homogeneous brightness to be achieved in the reconstructed hologram image.

One or more light-emitting diodes can be used as the light source 3. If a plurality of light-emitting diodes are used, they can be arranged next to one another, for example, in a direction transverse to the first direction (here along the x-direction (FIG. 3)). The light-emitting diodes L1, L2, L3 and L4 can, for example, emit light of the same color or light of different colors. Preferably, the light-emitting diodes L1-L4 are all arranged in one plane. In the embodiment described here, the light-emitting diodes L1 and L3 emit red light and the light-emitting diodes L2 and L4 emit green light. For this purpose, the image hologram 19 is designed such that it comprises an exposed first image for the radiation emitted by the light-emitting diodes L1, L3, and an exposed second image for the green radiation emitted by the light-emitting diodes L2 and L4. Preferably, the light source 3 is controlled by means of a control unit 20, which may but does not have to be part of the holographic display 1, such that none of the light-emitting diodes L1-L4 emit light, only the light-emitting diodes L1 and L3 emit light, or only the light-emitting diodes L2 and L4 emit light. This allows the first image or the second image in the transparent base body 4 to be selectively generated or switched on for a user.

In the described use with multiple colors, the image hologram 19 can comprise two holograms arranged one on top of the other (one for each corresponding color). However, it is also possible that the image hologram 19 is present as a multiplex structure in which a plurality of gratings are written into a hologram foil.

The input-coupling element 17 can also be designed as a hologram. When using multiple colors, the input-coupling element 17 can be designed as a stack of holograms (one hologram for each color) or as a multiplex structure.

The holographic display 1 can be designed such that the radiation 16 from the light source 3 enters the base body 4 via the rear side 6 without passing through further optical components and, after passing through the second glass layer 13, the third layer 11 and the first layer 7, is incident on the input-coupling element 17. The input-coupling element 17 can be designed here such that it only deflects the radiation 16. However, it is possible that the input-coupling element 17 additionally provides, for example, an optically imaging function, such as a lens function.

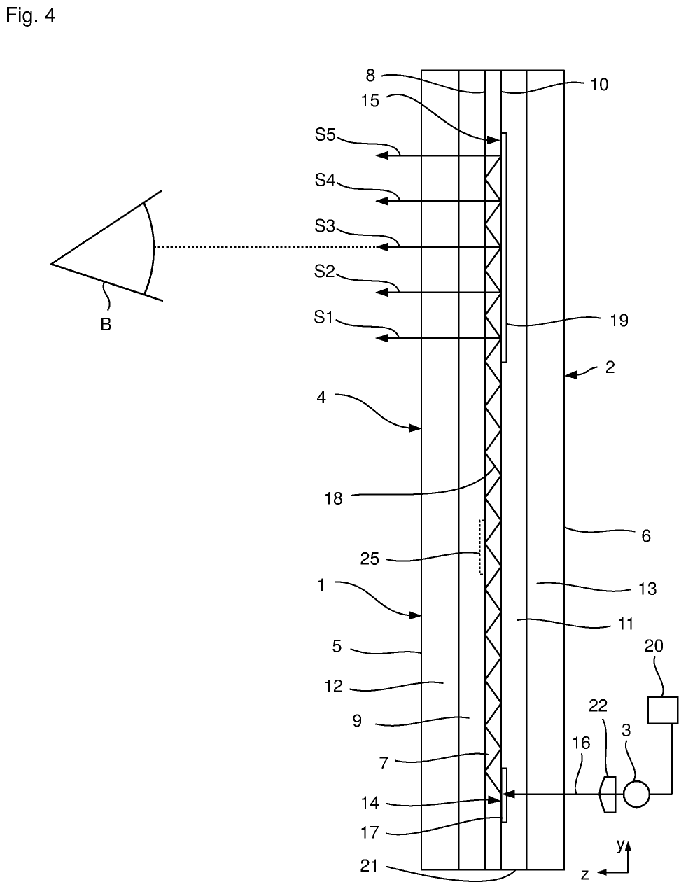

Of course, the radiation 16 can also be coupled into the transparent base body 4 via the front side 5 or via the lower end face 21. Furthermore, the input-coupling element 17 can be designed not only reflectively, as is shown in FIG. 1. It is also possible that the input-coupling element 17 is transmissive, as shown schematically in FIG. 4.

In the same way, the image hologram 19 can be designed not only to be transmissive, as is shown in FIG. 1. It is also possible that the image hologram 19 is reflective (FIG. 4).

Furthermore, the embodiment according to FIG. 1 can also be modified such that the image hologram 19 is designed as a reflection hologram. The light would then first pass through the hologram material of the image hologram 16, then be reflected by total internal reflection at the interface between the hologram material and the second layer 9, and then be diffracted in reflection in the hologram material of the image hologram 19.

The image hologram 19 is in particular designed to be substantially transparent, so that a user B can look through the transparent base body 4 when viewing the image hologram 19 when the light source 3 is switched off.

Furthermore, it is possible to interpose one or more optical components, such as one or more lenses, between the light source 3 and the transparent base body 4. FIG. 1 schematically shows a cylindrical lens 22.

Since the image hologram 19 in the embodiment described here has a relatively large extent in the x-direction, a very large number of channels, arranged next to one another, with light-emitting diodes and rotationally symmetric collimation lenses would be necessary to fully light the entire image hologram 19 in the x-direction. The described cylindrical lens 22 is used instead, which collimates the light from the light-emitting diodes in the y-direction (in the vertical direction) and does not perform any light shaping in the horizontal direction (x-direction). This allows broad lighting to be achieved in the horizontal direction, although only a few light-emitting diodes are necessary at the same time.

The cylindrical lens 22 also has the advantage that only one optical element is required to shape the light from all light-emitting diodes L1-L4. This minimizes the adjustment effort compared with a design in which a lens would be necessary for each light-emitting diode L1-L4.

In an advantageous development, the input-coupling hologram 17 also includes a cylinder function, which not only deflects the radiation 16 but also collimates it in the horizontal direction (x-direction) so that it can propagate under total internal reflection in the first layer 7. The combination of cylindrical lens and lens function of the input-coupling hologram 17 enables a geometrically broad plane wave (i.e. flat in two dimensions, so that the angular spectrum is as small as possible), which can be used to reconstruct the image hologram 19.

The input-coupling hologram 17 is particularly well suited for collimation in the x-direction, since it can extend over the entire extent of the base body 4, while the cylindrical lens 22 is better suited in the y-direction due to the divergence of the light from the light source, and thus a particularly simple arrangement for collimation in all directions can be provided.

In the described embodiment, the transparent base body 4 is designed as a plane-parallel plate. Of course, it is also possible that the front side 5 and/or the rear side 6 is/are curved. In this case, a deflection hologram 25 (dashed illustration in FIG. 1) can optionally be integrated along the propagation path between the input-coupling element 17 and the image hologram 19, which ensures that the angular spectrum of the input-coupled beam 18 is maintained and is not influenced by the curvature of the base body 4. Of course, a plurality of deflection holograms 25 can also be integrated along the propagation path. This can improve the homogeneity of the lighting of the image hologram 19.

Since the light guidance of the input-coupled beam 18 in the first layer 7 is achieved by means of total internal reflection due to the low refractive index of the second and third layers 9 and 11, the first glass layer 12 can, for example, be tinted or comprise an additional tinting layer, which, however, does not negatively influence the guidance of the input-coupled beam 18. For example, a tint of 30% would already mean that, after a distance of 30 cm between the input-coupling element 17 and the image hologram 19, less than 1% of the input-coupled radiation 16 can propagate through the waveguide.

The refractive index of the first layer 7 is preferably greater by at least 0.005 than the refractive index of the second layer 9 and preferably greater by at least 0.005 than the refractive index of the third layer 11.

For example, PVB (polyvinyl butyral) with a refractive index in the range of 1.37 to 1.47 can be used in each case for the second and third layers 9, 11, which are designed in particular as adhesive layers, and PC (polycarbonate) with a refractive index of 1.58 can be used for the first layer. Alternatively, it is possible, for example, to use EVA (ethylene vinyl acetate copolymer) with a refractive index in the range of 1.37 to 1.47 in each case for the second and third layers 9, 11 and to use PET (polyethylene terephthalate) with a refractive index of 1.56 for the first layer 7. In these examples, the input-coupled beam 18 can then be guided in the first layer 7 at an angle of greater than 61° to 71° (depending on the exact choice of refractive index for the second and third layers 9, 11).

The first layer 7 and also the second and third layers 9, 11 preferably have an extinction coefficient which is in each case less than 0.001. It is also advantageous if the three layers 7, 9, 11 exhibit a very small scattering behavior. The haze values should be less than 2 in order to keep the light loss due to scattering—analogous to the light loss due to absorption—as low as possible (detailed information regarding the haze value can be found, for example, in DIN EN ISO 13803:2015-02, DIN EN 2155-9:1989-11, DIN EN 62805-1:2018-06, DIN EN 1096-5:2016-06, and DIN ISO 15082:2018-02).

It is advantageous to use an amorphous material for the first layer 7 in order to avoid interference during the light guidance caused, for example, by stress birefringence in the first layer 7. Examples of such an amorphous material are float glass and highly transparent thermoplastics such as PMMA, PC, PVC, COC, PET, etc. It is important, especially when using semi-crystalline plastics such as PMMA and PET, that special attention must be paid to the manufacturing conditions so that the degree of crystallinity and thus the stress birefringence of the final product is as small as possible. For transparent materials that are obtained directly by polymerization (e.g. thermosets and epoxy resins or 2K acrylate systems), the manufacturing conditions likewise have an enormous influence on the stress birefringence of the final product. Furthermore, it is advantageous to use a material for the first layer 7 that is as free of streaks as possible in order to avoid the undesirable lens effect of the streaks and thus not to influence the light guidance. Here, too, float glass and highly transparent thermoplastics such as PMMA, PC, PVC, COC, PET, etc. can be used. It is important here, especially when using semi-crystalline plastics such as PMMA and PET, that special attention must be paid to the manufacturing conditions so that the degree of crystallinity and thus the stress birefringence of the final product is as small as possible. For transparent materials that are obtained directly by polymerization (e.g. thermosets), the manufacturing conditions likewise have an enormous influence on the stress birefringence of the final product.

The first layer 7 can have a layer thickness in the range of 50 μm to 2 mm (preferably up to 1 mm). Furthermore, the first layer can, for example, have a thickness of 70 to 500 μm if it is formed as a PC layer. The second and third layers 9, 11 can, for example, each have a thickness of 100 to 2000 μm if they are formed as a PVB layer or as an EVA layer.

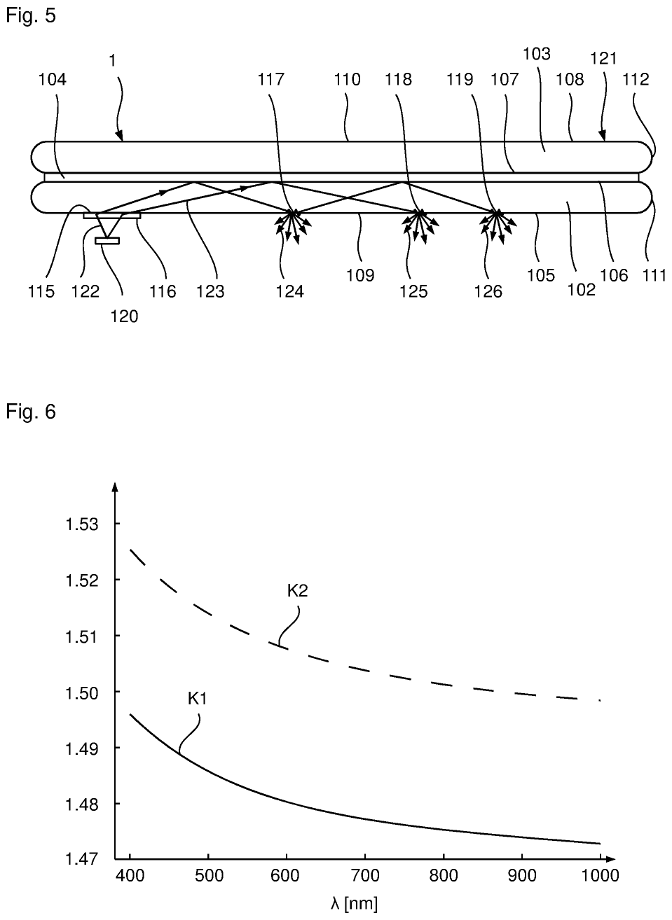

In the embodiment shown in FIG. 5, the waveguide 1 is designed as a laminated glass pane 1 for a vehicle with an inner pane 102 and an outer pane 103 which is bonded to the inner pane 102 via an adhesive layer 104. The inner pane 102 thus corresponds to the previously described first layer 7, and the outer pane 103 thus corresponds to the previously described second layer 9.

Although this embodiment and the further following embodiments each describe a laminated glass pane 1 for a vehicle, this is only an example of the waveguide, which can be designed as a laminated glass pane for a vehicle, but does not have to be designed as a laminated glass pane for a vehicle.

The laminated glass pane 1 shown schematically and not to scale in FIG. 5 can be designed in particular as a pane for a vehicle roof through which a person in the vehicle can look. The outer pane 103 can be tinted. However, it can also be completely transparent.

The inner pane 102 is preferably completely transparent. The same applies to the adhesive layer 104.

The inner pane 102 comprises a first side 105 oriented away from the outer pane 103 (or a first side 105 facing away from the outer pane 103) and a second side 106 oriented toward the outer pane 103 (or a second side 106 facing the outer pane 103). The outer pane 103 comprises a third side 107 oriented toward the inner pane 102 and a fourth side 108 oriented away from the inner pane 102. The two panes 102, 103 are bonded together via the mutually facing sides 106, 107 by means of the adhesive layer 104.

When using the laminated glass pane 1 shown in FIG. 5 in a vehicle roof, the first side 105 of the inner pane 102 is oriented toward the interior of the vehicle and can therefore also be referred to as the inner side 109 of the laminated glass pane 1. The fourth side 108 of the outer pane 103 is oriented away from the interior of the vehicle and can therefore be referred to as the outer side 110 of the laminated glass pane 1.

The inner pane 102 further comprises a first edge 111 connecting the first and second sides 105, 106, which is curved (preferably convex). In particular, the edge has what is known as a C-cut. A C-cut is understood here in particular to mean that the edge surface has a round cut. When viewed in cross section, the edge surface is thus round or C-shaped, or the edge surface has the shape of a circular arc or an elliptical arc, for example. Similarly, the outer pane 103 comprises a second edge 112 connecting the third and fourth sides 107, 108, which is curved. The second edge 112 can likewise have a C-cut.

The inner pane 102 further comprises an input-coupling region 115 at which a transmission grating 116 is provided. Furthermore, the inner pane 102 comprises a first, a second and a third output-coupling region 117, 118 and 119, which are spaced apart from the input-coupling region 115 and are spaced apart from one another. In the embodiment shown in FIG. 5, the output-coupling regions 117 to 119 are formed on the first side 105 of the inner pane 102.

Together with the light source 120 shown in FIG. 5, the laminated glass pane 1 forms an illumination system 121 for a vehicle.

The light source 120 emits radiation 122 (e.g. white light), which is incident on the input-coupling region 115 with the transmission grating 116. The transmission grating 116 deflects the radiation 122 such that it propagates as input-coupled radiation 123 to the output-coupling regions 117 to 119 due to reflections at the first and second sides 105, 106 of the inner pane 102. The reflections at the first and second sides 105, 106 are preferably total internal reflections. For this purpose, the refractive indices of the adhesive layer 104 and the inner pane 102 are selected accordingly. The refractive index of the adhesive layer 104 is therefore smaller than the refractive index of the material of the inner pane 102. The adhesive layer 104 can, for example, be formed as a PVB layer (polyvinyl butyral layer). In this case, the refractive index curve of the adhesive layer 104, shown in FIG. 6 with the solid line K1, is for a wavelength range of 400 to 1000 nm.

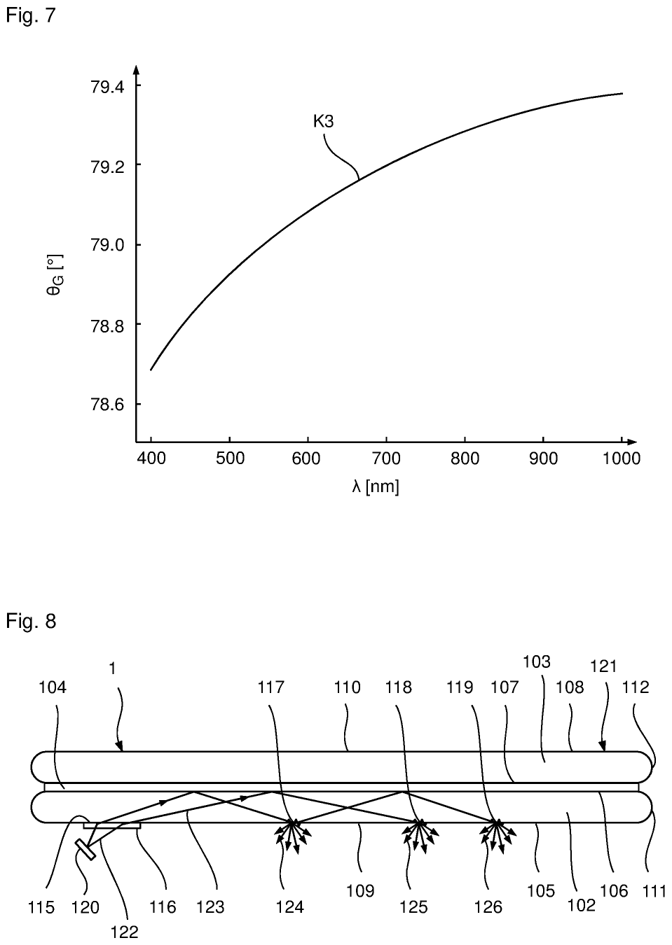

In FIG. 6, the wavelength A in nm is plotted along the abscissa and the refractive index along the ordinate. A typical glass for automotive panes has the refractive index curve shown as a dashed line (curve K2) in FIG. 6. As can be seen from the illustration, there is a refractive index difference of approximately 0.03 (depending on the wavelength). This leads to a critical angle for total internal reflection, which is shown in FIG. 7 for the wavelengths from 400 to 1000 nm. This critical angle is approximately 78.7° to 79.4° (depending on the wavelength).

In FIG. 7, the wavelength λ in nm is plotted along the abscissa and the critical angle θ_{G} in ° is plotted along the ordinate (curve K3). This means that, at angles of incidence on the second side 106 which are greater than this critical angle, the input-coupled radiation 123 is reflected by total internal reflection at the interface between the second side 106 and the adhesive layer 104.

The adjoining medium at the first side 105 is air with a refractive index of approximately 1, and so the corresponding critical angle for total internal reflection is smaller than that described for the second side 106. Thus, if total internal reflection for the input-coupled radiation occurs at the second side 106, this then also applies to the reflection at the first side 105.

The input-coupled radiation 123 thus guided in the inner pane 102 is then incident on the output-coupling regions 117, 118, 119, which are designed here such that they couple out at least a portion of the radiation that is incident on them as diffuse radiation, as indicated by the arrow bundles 124, 125 and 126 in FIG. 5. For a person in the vehicle looking at the inner side 109, the output-coupling regions 117, 118 and 119 are illuminated points. With appropriate distribution of the output-coupling regions 117 to 119 on the inner side 109, the impression of a starry sky can be created, for example.

In particular, the output-coupling regions 117 to 119 can be designed such that they have different output-coupling efficiencies, so that the output-coupled light intensities differ at the individual output-coupling regions 117, 118 and 119. This allows brighter and darker stars to be displayed.

Of course, it is also possible to adjust the output-coupling efficiencies of the output-coupling regions 117-119 such that the output-coupled light intensities at two or more output-coupling regions 117-119 are the same.

In the illumination system 121 shown in FIG. 5, the propagation direction of the radiation 122 coming from the light source 120 is such that it is normally incident on the first side 105. However, it is also possible that the propagation direction of the radiation 122 has an angle of other than 90° to the first side 105, as shown in FIG. 8.

In the embodiments according to FIGS. 5 and 8, the grating 116 is always designed as a transmission grating.

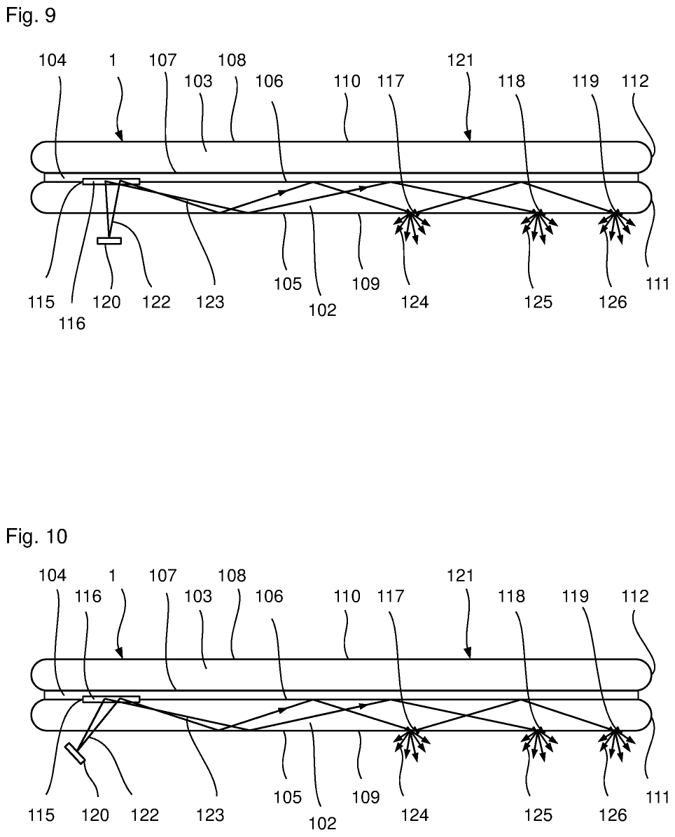

Furthermore, the grating 116 can be designed as a reflection grating. In this case, the preferred arrangement of the grating 116 is on the second side 106. This is shown in FIGS. 9 and 10 for normal incidence of the radiation 122 on the first side 105 (FIG. 9) and for an angle of incidence of the radiation on the side 105 that is not equal to 90° (FIG. 10).

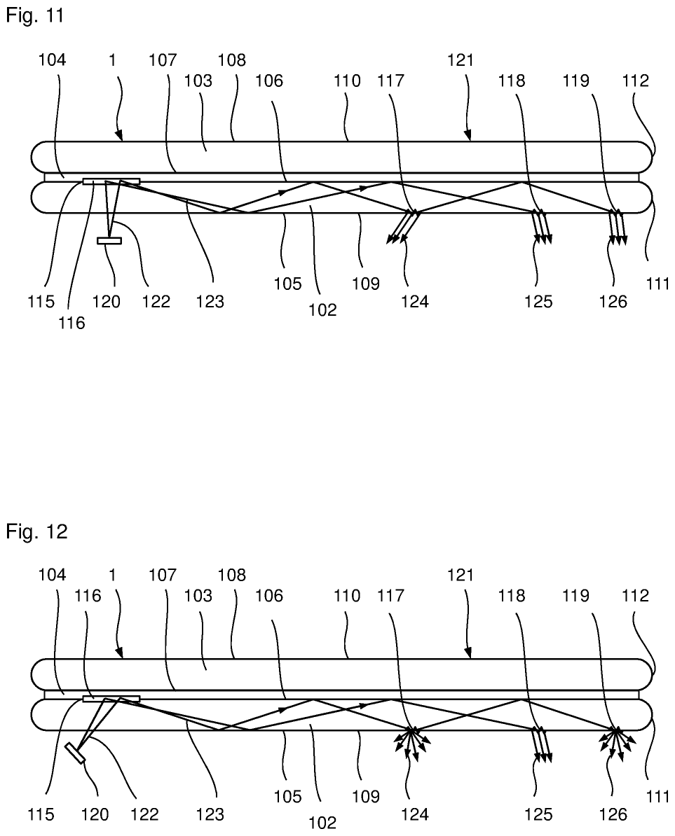

FIG. 11 shows a modification of the laminated glass pane 1 of FIG. 9, in which the output-coupling regions 117-119 are designed such that the output-coupled radiation is emitted as directed radiation. This can be used, for example, to implement a reading light or reading lighting for a person inside the vehicle.

FIG. 12 shows a modification of the laminated glass pane of FIG. 10. In this modification, the second output-coupling region 118 is designed such that it couples out the radiation 123 as directed radiation, which in turn makes it possible to implement a reading light. The first and third output-coupling regions 117 and 119 are designed such that the radiation 123 is emitted as diffuse radiation.

The grating 116 in FIGS. 5 and 8 to 12 can be designed, for example, as a volume hologram or as a relief grating.

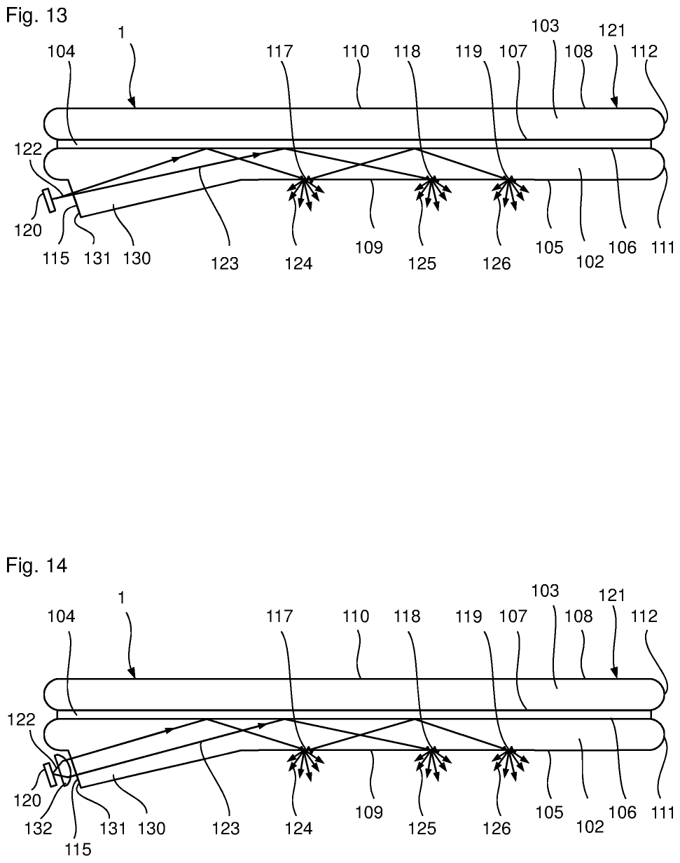

FIG. 13 shows a modification in which the inner pane 102 comprises a section 130, projecting from the first side 105, with a planar entrance surface 131. Thus, the inner pane 102 has a greater thickness in the region of the projecting section 130 than, for example, in the region in which the output-coupling regions 117-119 are located. Due to the projecting section 130, the inner pane 102 comprises a cross-sectional expansion in this region compared, for example, with the region in which the output-coupling regions 117-119 are located. The inclination of the planar entrance surface 131 relative to the first side 105 is preferably selected here such that radiation 122 entering perpendicularly via the planar entrance surface 131 has such an angle relative to the second side 106 that the desired total internal reflection takes place at the second side 106.

FIG. 14 shows a development of the embodiment according to FIG. 13. In this development, a lens 132 is arranged between the light source 120 and the entrance surface 131.

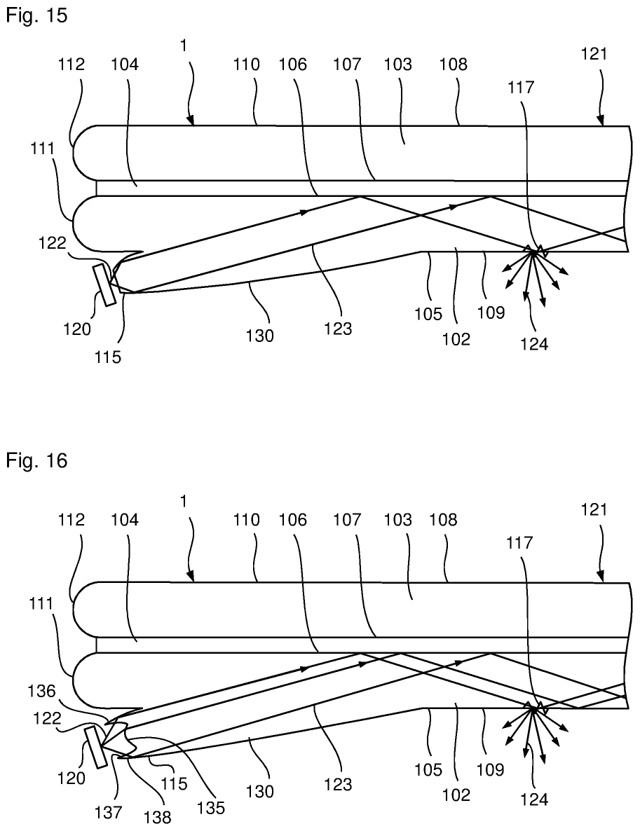

FIG. 15 shows a modification of the laminated glass pane 1 of FIG. 13 in an enlarged detailed view. The inwardly projecting section 130 is designed as an inverted collector in such a way that the radiation 122 coming from the light source 120 is shaped as a substantially parallel beam 123 which is incident on the second side 106 at the necessary angle of incidence in order to be reflected by means of total internal reflection. For example, a parabolic light collecting lens (compound parabolic concentrator) can be used upside down as a collimation optical unit (compound parabolic collimator). Such a collimation optical unit is preferably reflective and non-imaging. It comprises at least one rotationally symmetric parabolic surface which collect(s) the light from a light source with a defined angular spectrum. The length of the collimation optical unit can be used to set which angular spectrum of the radiation 122 coming from the light source 120 can be shaped as a substantially parallel beam 123.

FIG. 16 shows a modification of the laminated glass pane of FIG. 15, in which a lens-shaped entrance surface 135 with an annular projection 136 is formed instead of the planar entrance surface 131. The portion of the radiation 122 which passes through the inner side 137 of the annular projection 136 is reflected at the outer side 138 of the annular projection 136 by total internal reflection and thus redirected toward the second side 106.

In other words, the input-coupling region 115 comprises a TIR lens (TIR=total internal reflection). A TIR lens is an optical component that combines a reflector and a lens. In the center is a lens, which is surrounded annularly by a (possibly free-form) paraboloid. The transition region between the lens and the paraboloid is usually arranged concentrically around the light source. However, there may also be a deviation from the concentric shape in combination with a free-form paraboloid. The deflection over the parabolic surfaces occurs via total internal reflection.

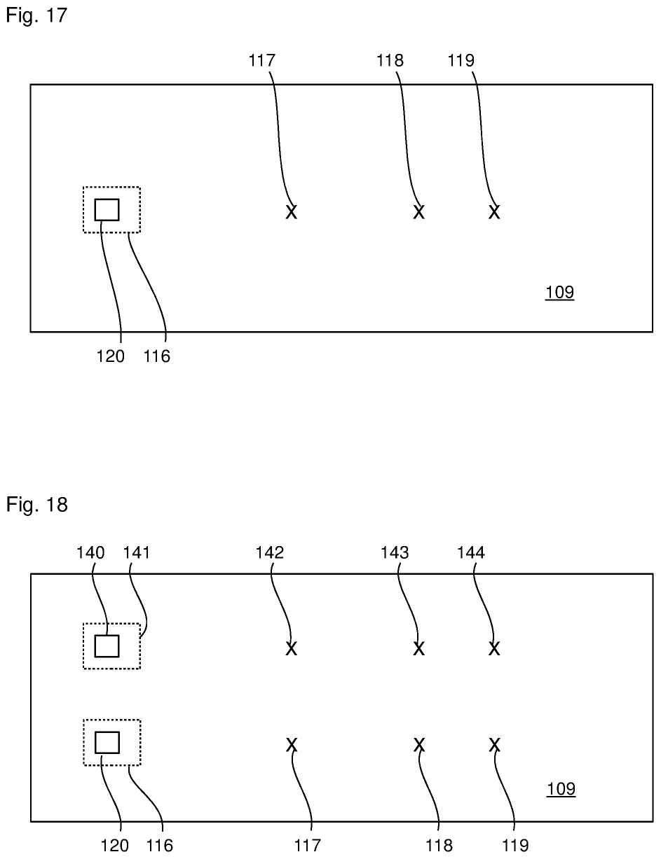

FIG. 17 shows a schematic view of the inner side 109 of the laminated glass pane 1 of FIG. 5. The output-coupling regions are indicated by “x.” Of course, the output-coupling regions 117 to 119 are designed in such a way that, when the light source 120 does not emit radiation 122, they are not visible but transparent. The grating 116 is also preferably designed such that it is transparent to a viewer.

FIG. 18 shows a modification of the laminated glass pane 1 according to FIG. 17 or of the illumination system 121 in the same way as in FIG. 17. In this modification according to FIG. 18, a further light source 140, a further input-coupling grating 141 and further output-coupling regions 142, 143 and 144 are provided. Of course, more than two light sources can also be provided. It is also possible that the light from a further light source does not run from left to right in the inner pane 102 as seen in FIG. 18, but from bottom to top or from top to bottom in the inner pane 102.

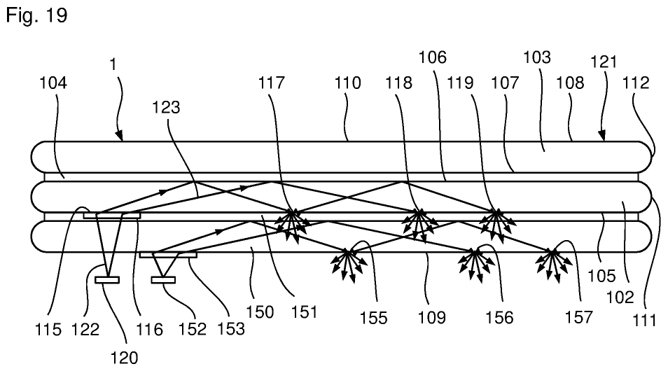

In FIG. 19, a modification of the described embodiments is described in such a way that a further pane 150 is bonded on the inner pane 102 by means of a further adhesive layer 151. This can be used to guide the light from a further light source 152, which is coupled into the further pane 150 via an input-coupling element 153, and to emit it as directed or non-directed radiation via corresponding output-coupling regions 155, 156 and 157. The remaining structure of the further pane 150 as well as the corresponding input-coupling region 153 and the further output-coupling regions 155-157 can be as described in connection with the inner pane 102. The inner pane 102 and the further pane 150 can thus also be referred to as the first and second light guides. The different light guides can also be used to guide and emit light of different wavelengths. The light sources 120 and 152 are designed accordingly for this purpose.

Of course, not only two light guides may be provided. Three or more light guides can also be formed in the same way on top of one another as a stack.

With the two or more light guides, for example, different output-coupling structures or different output-coupling regions can be present on the light guides. For example, different light signatures or images can thus be realized. In particular, these can be switched on and off individually

The output-coupling regions described so far were based on substantially point-shaped output-coupling regions 117-119, 141-143 and 155-157 or on output-coupling regions 117-119, 141-143 and 155-157 with a small lateral extent compared with the distance between the output-coupling regions 117-119, 141-143 and 155-157. However, it is also possible to provide one two-dimensional output-coupling region or a plurality of two-dimensional output-coupling regions.

If the output-coupling region is two-dimensional, it can be designed in such a way that it couples out the input-coupled radiation diffusely or in a directed manner. In particular, it is possible that the two-dimensional output-coupling region is designed as a volume grating into which image information has been exposed. When illuminated with the input-coupled radiation, the image can then be reconstructed such that a person in the vehicle can perceive the exposed image. In this case, the output-coupling region can be designed as an image hologram. In particular, the image hologram can be designed as an image plane hologram such that it is perceptible to the person in the vehicle as an image in the inner pane 102.

In the described embodiments, the laminated glass pane 1 is shown with a planar outer side 100 and a planar inner side 109. Of course, the laminated glass pane 1 can be curved. In this case, the outer side 100 and/or the inner side 109 can be curved. In particular, the two panes 102, 103 can also each comprise two curved sides 105-108, wherein the second and third sides 106 and 107 of the inner pane 102 and of the outer pane 103 facing one another preferably comprise complementary curvatures, so that a laminated glass pane 1 that is as thin as possible can be produced.

The thickness of the inner pane 102 and of the outer pane 103 can in particular be in the range from greater than 2 mm up to 5 mm.

While the invention has been described in connection with what is presently considered to be the most practical and preferred embodiments, it will be apparent to those of ordinary skill in the art that the invention is not to be limited to the disclosed embodiments. It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products. Moreover, features or aspects of various example embodiments may be mixed and matched (even if such combination is not explicitly described herein) without departing from the scope of the invention.

1-12. (canceled)

13. A waveguide for displaying an image, comprising:
a transparent base body with a front side and a rear side,
wherein the base body comprises an input-coupling region and an output-coupling region, which is spaced apart therefrom in a first direction and comprises an image hologram with an exposed image,
wherein the input-coupling region is configured to deflect at least a portion of radiation coming from a light source such that the deflected portion propagates as an input-coupled beam in the base body to the output-coupling region by reflection and is incident on the image hologram,
wherein the image hologram is configured to deflect at least a portion of the incident beam for reconstructing the exposed image such that the deflected portion exits the base body via the front side or rear side, with the result that the exposed image is perceptible to a viewer,
wherein the base body is multi-layered and comprises at least a first layer with a first refractive index and a second layer formed thereon with a second refractive index, which is smaller than the first refractive index, and
wherein the input-coupled beam propagates in the first layer due to total internal reflection at the interface to the second layer.

14. The waveguide of claim 13,
wherein a third layer is formed on a side of the first layer that is oriented away from the second layer,
wherein the third layer has a third refractive index which is smaller than the first refractive index, and
wherein the input-coupled beam propagates in the first layer due to total internal reflection at the interface to the third layer.

15. The waveguide of claim 13,
wherein the image hologram has a first extent in the first direction which is greater than an extent of the beam cross section of the input-coupled beam in the first direction,
wherein the input-coupled beam propagates in the first layer such that it is incident on the image hologram multiple times at different locations which are offset from one another along the first direction, and
wherein at each incidence a portion of the incident beam is deflected for reconstructing the exposed image.

16. The waveguide of claim 15, wherein the image hologram has an efficiency curve in which the deflection efficiency increases from a first to a last incidence of the beam.

17. The waveguide of claim 13, wherein the image hologram is an image plane hologram, in which the reconstructed image is perceptible as an image in the transparent base body.

18. The waveguide of claim 13, wherein the first layer is formed from an amorphous material.

19. The waveguide of claim 13, wherein the first refractive index is greater by at least 0.005 than the second refractive index.

20. The waveguide of claim 13, wherein an extinction coefficient of the first layer and an extinction coefficient of the second layer are each respectively less than 0.001.

21. The waveguide of claim 13, wherein the input-coupling region comprises a hologram for deflecting the radiation coming from the light source.

22. The waveguide of claim 13, wherein the exposed image of the image hologram displays a starry sky.

23. The waveguide of claim 22, wherein the image hologram comprises a plurality of spaced-apart output-coupling regions, each of which deflects at least a portion of an incident beam such that the incident beam exits as diffuse radiation in order to display the starry sky.

24. A holographic display, comprising a light source and the waveguide of claim 13.
